(19) United States
(12) Patent Application Publication
(10) Pub. No.: US 2011/0015997 A1
(43) Pub. Date: Jan. 20, 2011

(54) ADVERTISEMENT SYSTEM FOR FUNCTIONALLY INTERFACING WITH TRAFFIC LIGHT PHASE DISPLAYS

(76) Inventors: Jeff Casey, Calgary (CA); Derek Page, High Point, NC (US)

Correspondence Address: MACCORD MASON PLLC, 300 N. GREENE STREET, SUITE 1600, P. O. BOX 2974, GREENSBORO, NC, 27402, US

(21) Appl. No.: 12/836,182

(22) Filed: Jul. 14, 2010

Related U.S. Application Data
(60) Provisional application No. 61/226,090, filed on Jul. 16, 2009.

(51) Int. Cl. G06Q 30/00; F16M 13/02

(52) U.S. Cl. 705/14.49; 248/218.4

(57) ABSTRACT

The disclosure is directed to systems and methods for advertising at a traffic light (TL). One embodiment includes an advertisement system for selective advertising in conjunction with a TL having at least one phase chosen from a green light phase and a red light phase. The system includes a processor and a database having advertising content. The system includes a TL interface in communication with the processor. The system also includes a display in communication with the processor for displaying advertising content.

### RELATED APPLICATIONS

The current application claims priority to U.S. Patent Application No. 61/226,090 filed 16 Jul. 2009.

### BACKGROUND

Traffic lights (TLs) are known in the art to control vehicular and pedestrian traffic. Commonly, TLs have at least a green light phase used to indicate “go”, and a red light phase used to indicate “stop”. In many instances, TLs also have a yellow light phase to indicate “prepare to stop”, “caution”, “slow down”, etc.

In terms of control and coordination, a variety of systems may be used to regulate light function and desired traffic movement. For example, systems may include clockwork mechanisms and/or computerized control and coordination systems that self-adjust phase duration to regulate the flow of traffic. TL phase duration may vary from TL to TL. For example, a TL red light phase may have a duration chosen from about 5 to about 60 seconds.

The current disclosure is directed to systems and methods for safely and effectively advertising during the various phase durations of a TL, for example, during a red light phase.

### SUMMARY

By way of summary, the disclosure is directed to systems and methods for advertising at a traffic light (TL). One embodiment includes an advertisement system for selective advertising in conjunction with a TL having at least one phase chosen from a green light phase and a red light phase. In this embodiment, the system includes a processor and a database having advertising content in communication with the processor. The system also includes a TL interface in communication with the processor for interfacing with the TL. Typically, the interface is configured to determine at least one TL phase chosen from green light phase, yellow light phase, and red light phase. The interface will also typically relay the determined TL status to the processor.

The system includes a display in communication with the processor for displaying advertising content.

In another embodiment, the invention includes a method of advertising at a TL. In this embodiment, the method includes positioning a display; positioning a processor in communication with a database having advertising content; establishing communication between the processor and a phase control system for the TL; and displaying advertising content from the database based on the TL phase.

The above summary was intended to summarize certain embodiments of the present invention. Systems and methods will be set forth in more detail in the figures and detailed description below. It will be apparent, however, that the detailed description is not intended to limit the present invention, the scope of which should be properly determined by the appended claims.

### BRIEF DESCRIPTION OF THE DRAWINGS

FIG. 1 shows one embodiment of a system according to the disclosure;

FIG. 2 shows a schematic of the system of FIG. 1; and

FIG. 3 shows one embodiment of logic employed by a processor of the system.

### DETAILED DESCRIPTION OF CERTAIN EMBODIMENTS

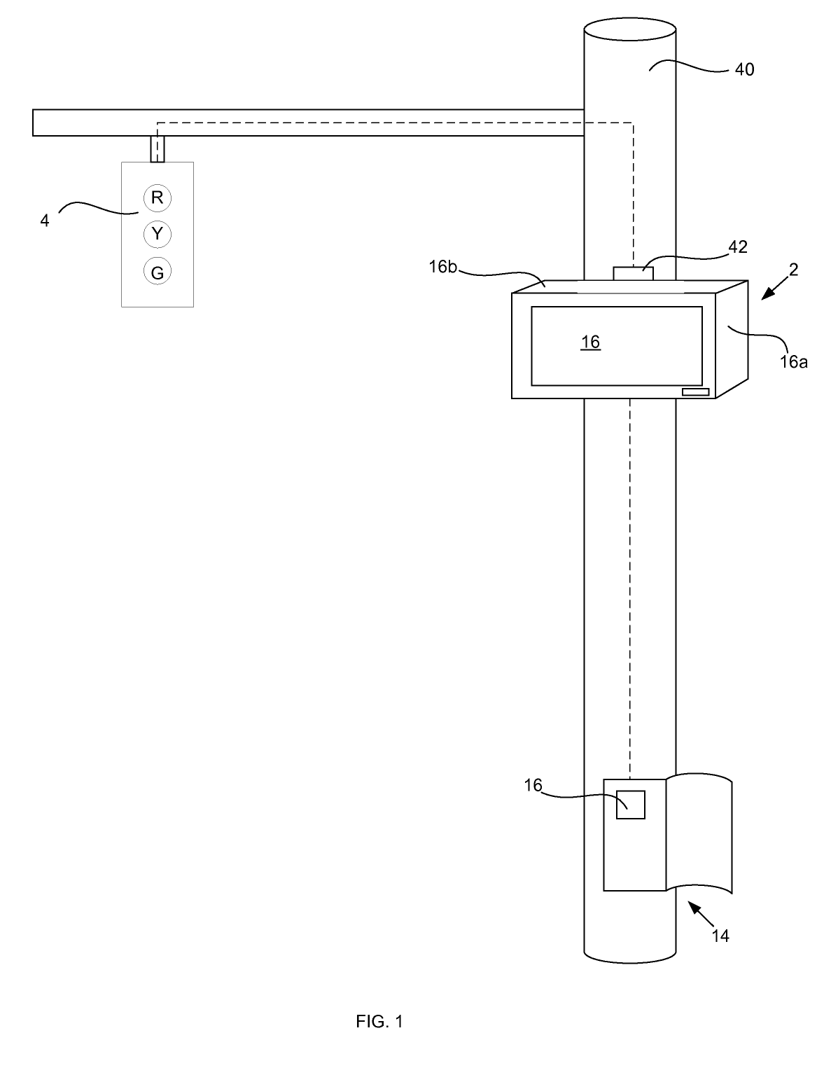

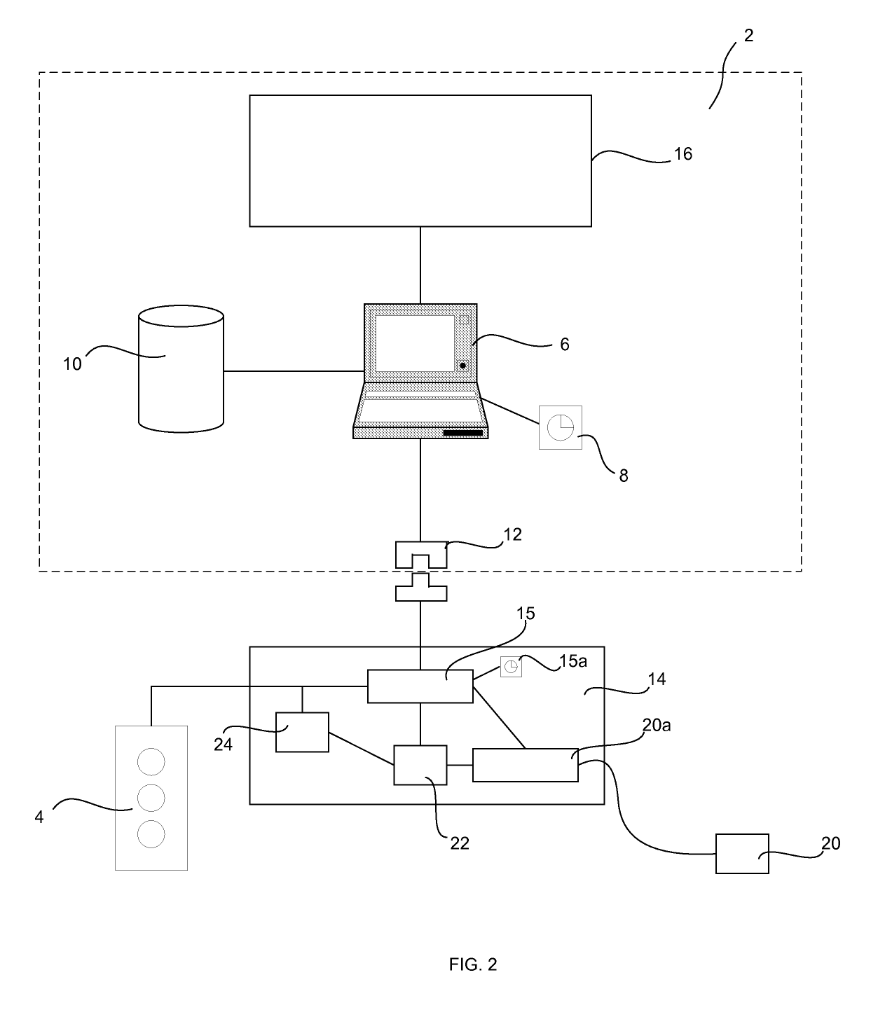

FIG. 1 shows one embodiment of an advertising system according to the instant disclosure functionally attached to a traffic light (TL). FIG. 2 shows a schematic representation of the system and TL shown in FIG. 1.

Referring to both FIGS. 1 and 2, in this embodiment, the disclosure includes advertisement system 2. System 2 performs selective advertising in conjunction with traffic light (TL) 4. A variety of TLs are known in the art. Typically, TLs have at least one phase chosen from a green light phase, a red light phase, and a yellow light phase; commonly, TLs include all three phases.

In this embodiment, system 2 includes process 6 in communication with database 10. Processors may vary from embodiment to embodiment, and may include, for example, laptop computers or smaller processing systems. Database 10 includes advertising content. Advertising content is typically categorized. For example, content may be sorted to morning commute content, midday content, evening commute content, evening content, and weekend content. Additionally, content may be categorized by duration, e.g., content for displaying during a short phase duration, content for displaying during a mid-length phase duration, or content for displaying during a long phase length duration. The actual length of the content may be determined, for example, based on the phase length at a given TL. Content may be localized content, national content, or both. In some embodiments, content will also include news or emergency content, e.g., news content, AMBER alerts, weather, etc. Advertising content may be updated as needed using a variety of methods. For example, content may be provided over the internet through a hardwired connection to the processer. Updates may be achieved wirelessly, e.g., over a cell or 3G network, or by manual uploads, etc.

System 2 may also include TL interface 12 in communication with processor 6. TL interfaces are configured to interface with the TL. Interface may vary from embodiment to embodiment, and from TL to TL. Common elements of interface functionality includes at least one of the ability to determine at least one TL phase chosen from green light phase, yellow light phase, and red light phase; and the ability to relay the at least one determined TL status to the processor.

System 2 also includes display 16, which may be, for example, a LCD display. Displays will typically be in communication with processors of the system. Referring primarily to FIG. 1, display 16 is covered in a protective case 16a to protect it from the elements. Embodiments may also include a sunshade, e.g., similar to 16b, to provide some shade from the sun. Display 16 is mounted to pole 40 by mounting bracket 42. Displays may be mounted to a variety of support structures and may include straps, clamps, bolts, etc. In some embodiments, displays may be suspended, e.g. from a horizontal pole, or mounted above a pole.

In a typical embodiment, processor 6 is configured to provide advertising content to display 6 when TL interface 12 determines that the TL phase is the desired phase, e.g. red. Processor 6 may optionally stop the advertising display prior to phase change, e.g., 5 seconds prior to the phase change from red to green, and initiate a visual countdown sequence, e.g., “5”, “4”, “3”, “2”, “1”. In some embodiments, a similar countdown protocol may be initiated to mark the green to yellow phase change, or the yellow to red phase change. Clock 8 may also be used to select content based on time. For example, morning commute advertising content may be displayed from 7:00 am to 8:00 am.

In many embodiments, processors are configured to stop display of advertising content at displays when the TL interface determines that the TL phase is green. Display stop may be achieved by at least one function chosen from turning off said display; not sending advertising content to said display; and displaying a non-advertising display, e.g., a solid color display, or non-moving picture.

In the embodiment shown, interface 12 interfaces with control panel 14 of TL 4. Control panels vary from TL system to TL system, but typically perform the common function of regulating TL phase. In this embodiment, phase control 15 regulates TL phase, and interface 12 interfaces with phase control 15. A variety of phase controls may be employed. For example, phase control may include a fixed time control for regulating TL phases, e.g., based on clock 16a. Phase control may include a dynamic control 5 for regulating TL phase, and the TL interface may interface with the dynamic control. Dynamic controls typically include detector 20 and detector interface 20. Detector 20 may be an in-pavement detector, e.g. at least one of a pressure detector or metal detector. Detector 20 may be a non-intrusive detector, e.g., at least one of a video sensor, EM wave sensor, light sensor or acoustic sensor. Control systems may also include other features, e.g. power supply 22 and signal override 24. In some embodiments, advertising systems may be controlled by the power supply of the TL control system, e.g., power supply 22. In other embodiments, advertising systems may have independent power systems, e.g., solar panels or batteries for providing power. Some embodiments may include both TL and independent power systems.

The instant disclosure is also directed to methods of advertising at a TL. In one embodiment the method includes positioning a display, e.g., display 16 positioned on pole 40, positioning a processor in communication with a database having advertising content; establishing communication between the processor and a phase control system for the TL; and displaying advertising content from the database based on the TL phase.

In one embodiment, establishing communication between the processor and a phase control system includes determining at least one TL phase, e.g. the phases mentioned above. Typically, establishing communication between the processor and a phase control system includes relaying at least one TL phase to the processor. In many embodiments, displaying is performed when the TL phase is red.

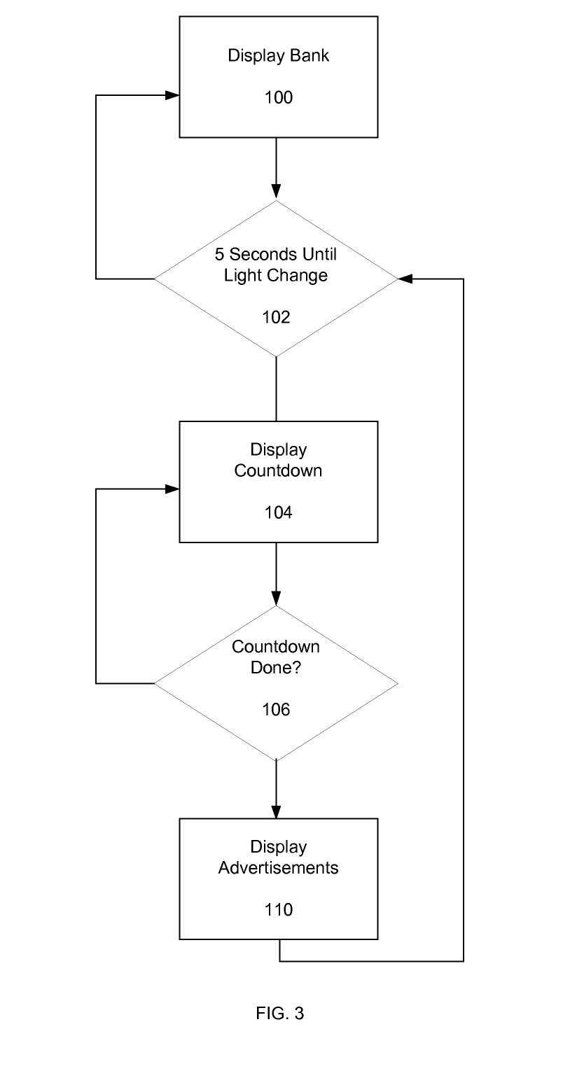

FIG. 3 represents logic that may be employed by a processor according to one embodiment of the instant disclosure. Block 100 represents a blank display, for example, when the processor sends a stop display signal to the display. Such a signal may be sent, for example, during a green light phase.

Block 102 represents determining the duration until phase change. For example, processor sends a stop display signal to the display until 5 seconds prior to light change.

Block 104 represents a countdown display prior to light change. When processor determines that countdown is complete (block 106) advertisement is displayed (block 110). Processors will typically select advertisement phase duration, based on at least one criteria, e.g., time of day, rotation cycle of content, etc. Additionally, several short advertisements could be displayed w/in a single display period.

When the processor determining the phase is about to change, block 102, e.g. back to green, the processor sends a blank display signal 100 to display.

Numerous characteristics and advantages have been set forth in the foregoing description, together with details of structure and function. The disclosure, however, is illustrative only, and changes may be made in detail, especially in matters of shape, size, and arrangement of parts, within the principle of the invention, to the full extent indicated by the broad general meaning of the terms in which the general claims are expressed.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all subranges subsumed therein, and every number between the end points. For example, a stated range of “1 to 10” should be considered to include any and all subranges between (and inclusive of) the minimum value of 1 and the maximum value of 10; that is, all subranges beginning with a minimum value of 1 or more, e.g. 1 to 6.1, and ending with a maximum value of 10 or less, e.g., 5.5 to 10, as well as all ranges beginning and ending within the end points, e.g. 2 to 9, 3 to 8, 3 to 9, 4 to 7, and finally to each number 1, 2, 3, 4, 5, 6, 7, 8, 9 and 10 contained within the range. Additionally, any reference referred to as being “incorporated herein” is to be understood as being incorporated in its entirety.

It is further noted that, as used in this specification, the singular forms “a,” “an,” and “the” include plural referents unless expressly and unequivocally limited to one referent.

What is claimed is:

1) An advertisement system for selective advertising in conjunction with a traffic light (TL) having at least one phase chosen from a green light phase and a red light phase, said system comprising:
a processor;
a database in communication with said processor, said database having advertising content;
a TL interface in communication with said processor and interfacable with said TL, said TL interface configured to
determine at least one TL phase chosen from green light phase, yellow light phase, and red light phase, and
relay said at least one determined TL status to said processor; and
a display in communication with said processor.

2) The system of claim 1, wherein said processor is configured to provide advertising content to said display when said TL interface determines that said TL phase is red light.

3) The system of claim 1, wherein said processor is configured to stop display of advertising content at said display when said TL interface determines that said TL phase is green light.

4) The system of claim 3, wherein said processor is configured to stop display by including at least one function chosen from turning off said display; not sending advertising content to said display, and displaying a non-advertising display.

5) The system of claim 4, wherein said non-advertising display includes a solid color display.

6) The system of claim 1, wherein said TL interface interfaces with a controller panel of said TL for regulation TL phase.

7) The system of claim 6, wherein said controller panel includes a fixed time control for regulating TL phase, and said TL interface interfaces with said fixed time control.

8) The system of claim 6, wherein said controller panel includes a dynamic control for regulating TL phase, and said TL interface interfaces with said dynamic control.

9) The system of claim 8, wherein said dynamic control includes at least one in-pavement detector.

10) The system of claim 9, wherein said at least one in-pavement detector includes at least one detector chosen from a pressure detector and a metal detector.

11) The system of claim 8, wherein said dynamic control includes at least one non-intrusive detector.

12) The system of claim 11, wherein said at least one non-intrusive detector includes at least one detector chosen from video sensor, EM wave sensor, and acoustic sensor.

13) The system of claim 1, wherein said display is in an LCD screen.

14) The system of claim 1, wherein said display is in a protective enclosure.

15) The system of claim 1, further including a mounting bracket configured to mount said display to a vertical support structure.

16) The system of claim 1, wherein said advertising content is categorized.

17) The system of claim 16, wherein said categorized advertising content is sorted to include at least one category chosen from morning commute content, midday content, evening commute content, evening content, and weekend content.

18) The system of claim 1, wherein said display is configured to display a numeric countdown.

19) The system of claim 18, wherein said display is configured to display a numeric countdown when said TL interface determines a yellow light phase.

20) A method of advertising at a traffic light (TL), said method comprising:
positioning a display;
positioning a processor in communication with a database having advertising content;
establishing communication between said processor and a phase control system for said TL; and
displaying advertising content from said database based on the TL phase.

21) The method of claim 20,
wherein said establishing communication between said processor and a phase control system includes determining at least one TL phase,
wherein said TL phase is chosen from green light phase, yellow light phase, and red light phase.

22) The method of claim 21, wherein said establishing communication between said processor and a phase control system includes relaying at least one TL phase to said processor, and wherein said displaying is performed when said TL phase is in said red light phase.
